(19) United States
(12) Patent Application Publication
(10) Pub. No.: US 2014/0108488 A1
(43) Pub. Date: Apr. 17, 2014

(54) INTEGRATION SYSTEM AND TEST SYSTEM FOR INCORPORATING PLURAL APPLICATION PROGRAMS

(71) Applicant: MStar Semiconductor, Inc., Hsinchu Hsien (TW)

(72) Inventor: Ying-Chou Chen, Hsinchu Hsien (TW)

(73) Assignee: MStar Semiconductor, Inc., Hsinchu Hsien (TW)

(21) Appl. No.: 14/049,545

(22) Filed: Oct. 9, 2013

(30) Foreign Application Priority Data
Oct. 11, 2012 (TW) 101137514

(51) Int. Cl. H04L 29/08

(52) U.S. Cl. CPC H04L 67/10
USPC 709/201

(57) ABSTRACT

An integration system includes a transmission port, a port management module, a first service module and a second service module. The port management module includes a port management unit for managing the transmission port. The first service module corresponds to a first application program among a plurality of application programs, and assists the first application program to communicate with the port management module. The second service module corresponds to a second application program among the application programs, and assists the second application program to communicate with the port management module. The port management module allows the first service module and the second service module to share a control authority of the port management unit.

This application claims the benefit of Taiwan application Serial No. 101137514, filed Oct. 11, 2012, the subject matter of which is incorporated herein by reference.

### BACKGROUND OF THE INVENTION

1. Field of the Invention

The invention relates in general to a testing technique, and more particularly, to a testing technique for incorporating multiple application programs.

2. Description of the Related Art

The assurance of product functionality when products are shipped out of the factory is a long-term focused issue by manufacturers. By screening and repairing defective products in advance, refunds, returns and exchanges after sales can be effectively prevented to enhance customer satisfaction. One development trend of consumer electronic products in the recent years is to integrate an ever-growing number of functions into one single electronic product. For example, in addition to a basic call function, a portable handset is also required to capture photographs and connect to the Internet. Correspondingly, a test system of electronic products thus needs to be equipped with multiple test capabilities for ensuring the functionality of the electronic products.

Different test items are generally performed by different test programs. A conventional test system frequently faces an issue that different test programs cannot share common hardware resources such as transmission ports. For example, once one test program occupies the usage rights for a communication interface such as a universal serial bus (USB) or universal asynchronous receiver/transmitter (UART) port of an object under test, another test program cannot send a command or capture an output signal through the communication interface. In practice, such issue may be solved by integrating all kinds of tests into one colossal test program. However, the integration of multiple test programs requires high costs. Further, when a new test item is later to be added, a great level of alteration to the colossal integrated test program may be involved.

### SUMMARY OF THE INVENTION

The invention is directed to an integration system and a test system for incorporating a plurality of application programs. Through architectures of the systems, a control authority of a transmission port can be shared by the application programs without making large alterations to codes of the individual application programs, thereby effectively solving the issue of one test program monopolizing the control authority of the transmission port.

According to an embodiment of the present invention, an integration system configured to incorporate a plurality of application programs is provided. The integration system comprises a first transmission port, a port management module, a first service module and a second service module. The port management module comprises a first port management unit for managing the first transmission port. The first service module corresponds to a first application program among the application programs, and assists the first application program to communicate with the port management module. The second service module corresponds to a second application program among the application programs, and assists the second application program to communicate with the port management module. When the first application program requests to communicate with the first transmission port, the port management module designates a control authority of the first port management unit to the first service module. When the second application program requests to communicate with the first transmission port, the port management module also designates the control authority of the first port management unit to the second service module. The port management module allows the first service module and the second service module to share the control authority of the first port management unit.

According to another embodiment of the present invention, a test system is provided. The test system comprises a first transmission port, a port management module, a first test program, a second test program, a first service module and a second service module. The port management module comprises a first port management unit for managing the first transmission port. The first service module corresponds to the first application program, and assists the first application program to communicate with the port management module. The second service module corresponds to the second application program, and assists the second application program to communicate with the port management module. When the first application program requests to communicate with the first transmission port, the port management module designates a control authority of the first port management unit to the first service module. When the second application program requests to communicate with the first transmission port, the port management module also designates the control authority of the first port management unit to the second service module. The port management module allows the first service module and the second service module to share the control authority of the first port management unit.

According to yet another embodiment of the present invention, a computer-readable storage medium is provided. The computer-readable storage medium stores a code readable and executable by a controller. The code assists a plurality of application programs to communicate with at least one transmission port. After an application program among the application programs raises a communication request, a first code of the code establishes a service module for the application program. When the application program requests to communicate with at one of the at least one transmission port, a second code of the code determines whether a port management unit corresponding to the transmission port exists. When the port management exists, the second code designates a control authority of the port management unit to the service module of the application program. When the port management unit does not exist, the second code establishes the port management unit, and designates the control authority of the port management unit to the service module of the application program. The second code allows the control authority of the port management unit to be shared by a plurality of service modules.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a test system according to an embodiment of the present invention.

FIG. 2 shows details of a test system of the present invention establishing a service module.

FIG. 3 is a block diagram of a test system according to another embodiment of the present invention.

FIG. 4 is a block diagram of a test system according to another embodiment of the present invention.

FIG. 5 is a block diagram of a test system according to another embodiment of the present invention.

FIG. 6 is a block diagram of an integration system according to an embodiment of the present invention.

### DETAILED DESCRIPTION OF THE INVENTION

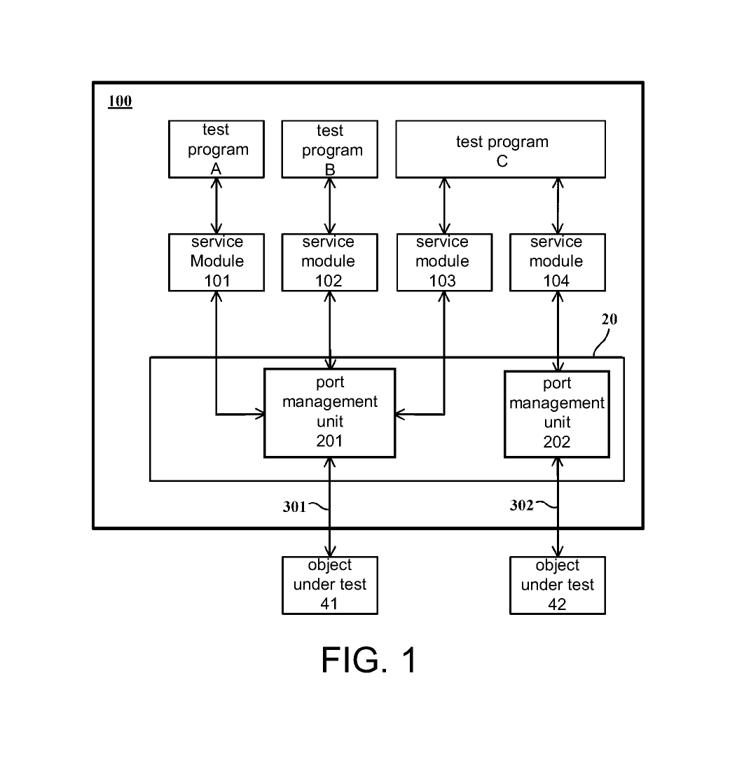

FIG. 1 shows a test system 100 according to an embodiment of the present invention. A service module 101 serves a test program A, a service module 102 serves a test program B, and service modules 103 and 104 serve a test program C. As shown in FIG. 1, the service modules 101, 102 and 103 are coupled to a port management unit 210. The service module 104 is coupled to a port management unit 202. The port management units 201 and 202 are included in a port management module 20. In the test system 100, each transmission port of each object under test is controlled by a port management unit. In the description of an example below, it is assumed that objects 41 and 42 under tests are mobile communication devices, a transmission port 301 between the port management unit 201 and the object 41 under test is a universal asynchronous receiver/transmitter (UART) port, and a transmission port 302 between the port management unit 202 and the object 42 under test is also a UART port.

In the embodiment, the test program A captures and stores a log file sent from the UART port 301 of the object 41 under test via the service module 101 and the port management unit 201. Via the service module 102 and the port management unit 201, the test program B sends a command to the UART port 301 of the object 41 under test to control the object 41 under test to send a request (e.g., a request of dialing a phone call to the object 42 under test) for establishing a communication to the object 42 under test. The test program C captures the log file sent from the UART port 301 of the object 41 under test via the service module 103 and the port management unit 201. According to the log file sent from the UART port 301 of the object 41 under test, the test program C determines whether the object 41 under test has already sent a request for establishing a communication to the object 42 under test. Further, the test program C also captures a log file sent from the UART port 302 of the object 42 under test via the service module 104 and the port management unit 202. According to the log file sent from the UART port 302 of the object 42 under test, the test program C determines whether the object 42 under test has received the communication request from the object 41 under test.

It is seen from the above description that, the test programs A, B and C, although having different tasks, all need to communicate with the object 41 under test via the UART port 301 thereof. Through the architecture of the test system 100, the test programs A, B and C are allowed to share the control authority of the UART port 301 of the object 41 under test without making large alterations to the codes of the test programs A, B and C, thereby preventing one test program from monopolizing the control authority of the UART port 301. As seen from FIG. 1, the port management unit 201 is in charge of managing the UART port 301 of the object 41 under test, and the test programs A, B and C are connected to the port management unit 201 via the service modules 101, 102 and 103, respectively. The communication requests between the test programs A, B and C with the UART port 301 of the object 41 under test are managed by the port management unit 201 in a centralized manner.

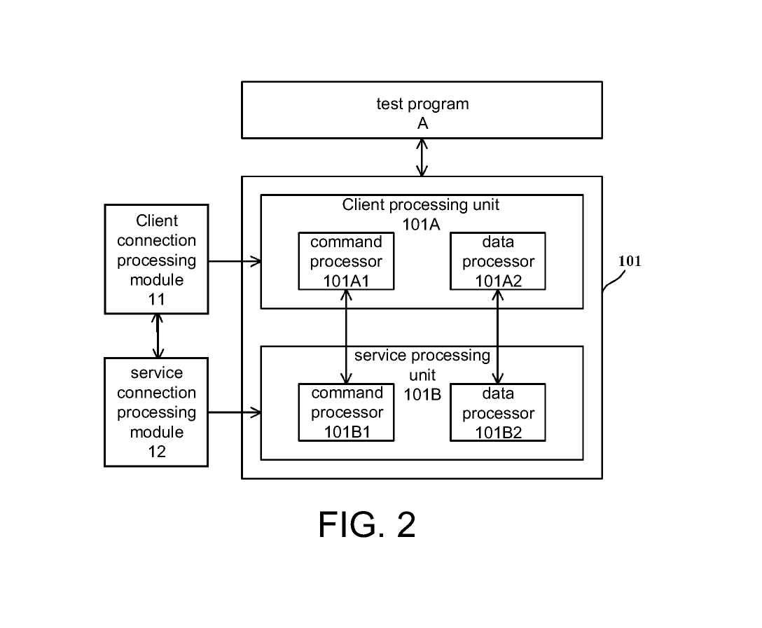

FIG. 2 shows details of the test system 100 establishing a service module by taking the service module 101 of the test program A, as an example. As shown in FIG. 2, the test system 100 may comprise a client connection processing module 11 and a service connection processing module 12. After the test program A raises a request for connecting to the test system 100, the client connection processing module 11 first requests the service connection processing module 12 to establish a service processing unit 101B for the test program A. The service processing unit 101B comprises a command processor 101B1 and a data processor 101B2. The service connection processing module 12 then informs the client connection processing module 12 of a channel name utilized by the command process 101B1. According to the channel name, the client connection processing module 11 establishes a client processing unit 101A dedicated to the test program A. The client processing unit 101A comprises a command processor 101A1 and a data processor 101A2. As shown in FIG. 2, a connection for transmitting a command is established between the command processor 101A1 and the command processor 101B1. Through the connection, the command processor 101A1 may inquire the command processor 101B1 for the channel name to be utilized to accordingly establish the connection for transmitting data between the data processor 101A2 and the data processor 101B2. At this point, the connection between the client connection processing module 11 and the service connection processing module 12 can be disconnected until the test program A or another test program again request for establishing a connection with an object under test to the client connection processing module 11.

Correspondingly, when a manufacturer develops a new test program, given that the test program has an ability of requesting a connection to the client connection processing module 11, the test program is able to establish a communication channel with multiple objects under test and multiple transmission ports coupled to the test system 100.

As previously stated, in addition to a service module, the communication between a test program and a transmission port needs to be performed further through a port management unit corresponding to the transmission port. After having established the service module 101, the connection between the client processing unit 101A and the service processing module 101B is established. The test program A may inform the client processing unit 101A of a transmission port (e.g., the UART port 301) to be utilized. The client processing unit 101A further raises a request to the port management module 20 via the service processing unit 101B. The port management module 20 first determines whether a port management unit (e.g., the port management unit 201) corresponding to the transmission port exists. If not, the port management module 20 establishes a port management unit corresponding to the transmission port, and designates the control authority of the port management unit to the first service module 101. Similarly, if the test program B later requests for a communication with the UART port 301, the port management module 20 also designates the control authority of the port management unit 20 to the service module 102 of the test program B. In other words, the port management module 20 allows multiple service modules to share the control authority of one single port management unit. For example, the control authority of the port management unit 202 in FIG. 1 may be later further shared to other service modules by the port management module 20.

As seen from FIG. 1, the test system 100 allows one test program to simultaneously correspond to multiple service modules (e.g., the test program C corresponds to the service modules 103 and 104). That is to say, a test program may simultaneously communicate with multiple transmission ports (e.g., the multiple transmission ports may be coupled to the same object under test or respectively coupled to different objects under test) via different service modules. In practice, the transmission port cooperating with the test system 100 is not limited to the foregoing UART port. For example, the test system 100 may also operate in coordination with one or more transmission interfaces from USB, Infrared Data Association (IrDA), Bluetooth, WiFi, transmission control protocol/internet protocol (TCP/IP), and general purpose interface bus (GPIB) transmission interfaces.

In practice, apart from capturing and replying data generated by an object under test, the service module may also be designed as further providing a function of replying filtered data according to a filter condition. For example, original data that the object 41 under test transmits to the UART port 301 may at the same time include a character log file and a numeric log file. When it is known that information of a request that the object 41 under test sends for establishing a communication is included in the character log file, the service module 103 may be configured to not transmit the numeric log file and to filter and provide only the character log file to the test program C.

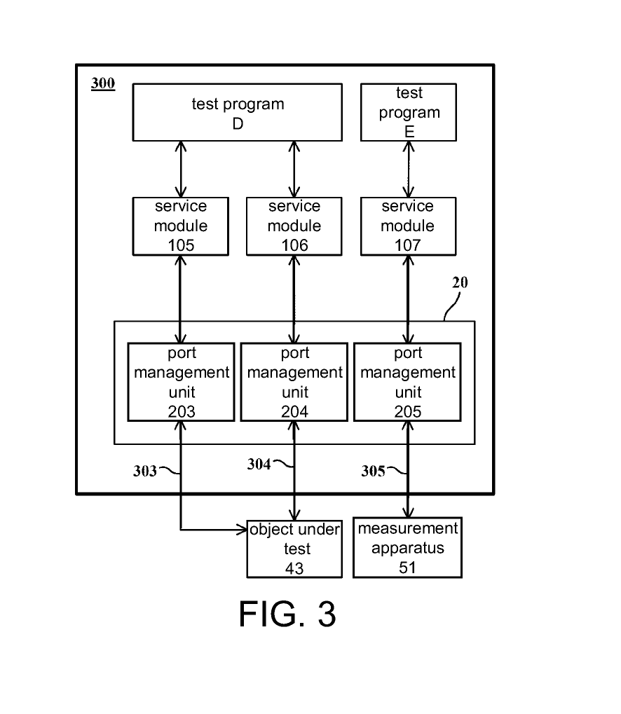

FIG. 3 shows a test system 300 according to another embodiment of the present invention. In the embodiment, service modules 105 and 106 serve a test program D, and a service module 107 serves a test program E. As shown in FIG. 3, the port management module 20 comprises port management units 203, 204 and 205. The service module 105 is coupled to the port management unit 203, the service module 106 is coupled to the port management unit 204, and the service module 107 is coupled to the port management unit 205. The test program D captures a log file of an object 403 under test and sent from a UART port 303 via the service module 105 and the port management unit 203, and sends a test command to the object 43 under test via the service module 106, the port management unit 204, and a USB port 304. The test program E captures a measurement result generated by a measurement apparatus 51 via the service module 107, the port management unit 205 and a GPIB port 305. The measurement result may be associated with the test command sent by the test program D to the object 43 under test.

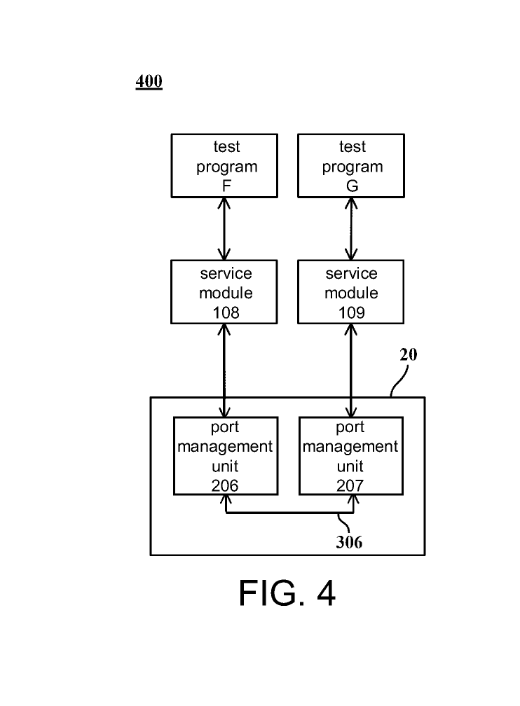

FIG. 4 shows a test system 400 according to another embodiment of the present invention. In the embodiment, a service module 108 serves a test program F, and a service module 109 serves a test program G. The port management module 20 comprises port management units 206 and 207. The service module 108 is coupled to the port management unit 206, and the service module 109 is coupled to the port management unit 207. It should be noted that, each of port management units 206 and 207 corresponds to a virtual transmission port and have an established connection channel 306 in between. A command or data sent by the test program D via the service module 108 and the port management unit 206 may be transmitted to the test program G via the connection channel 306, the port management unit 207 and the service module 109. For example, the test program G may simulate an object under test, and may be tested by the test program F in a temporary absence of the object under test or when functions of the object under test are not yet fully developed. A test result may in turn serve as a basis for determining whether the test program is functional.

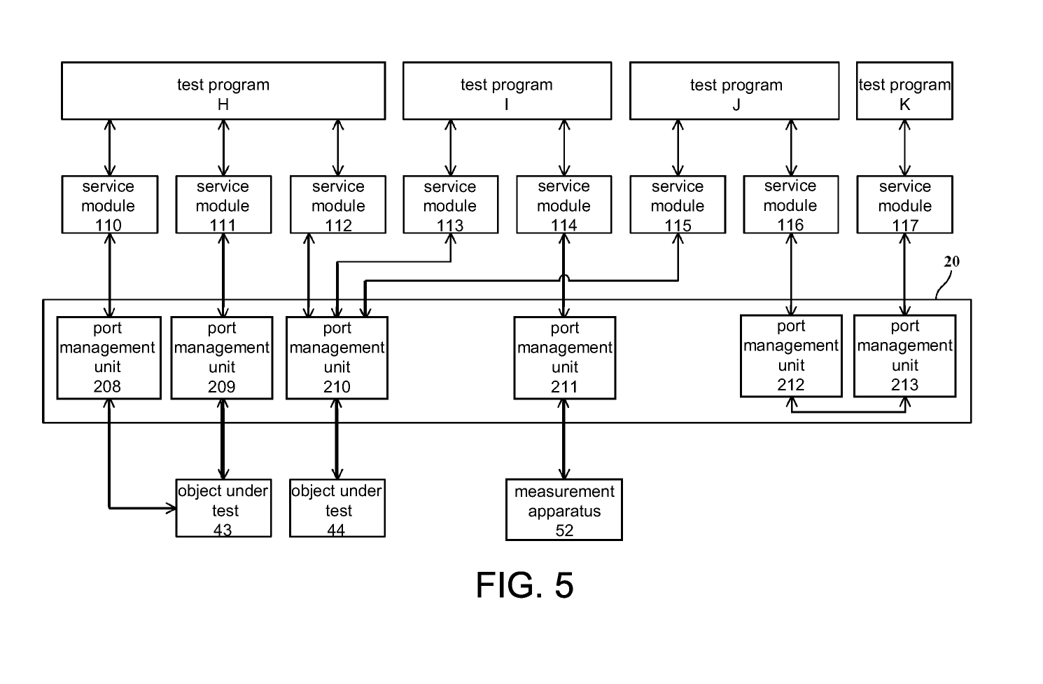

As shown in FIG. 5, connections of the test programs/service modules/port management units in FIGS. 1, 3 and 5 may be integrated into one test system. It should be noted that, the functions of the test programs, and the numbers of the test programs, the service modules and the port management units, are for explaining the embodiments and are not to be construed as limiting the present invention. Further, the concept of the present invention may be applied to a test system as well as an integration system for incorporating multiple application programs. For example, the objects 43 and 44 under test and the test apparatus 52 may be replaced by various kinds of electronic apparatuses, and test programs H, I, J and K may be replaced by other types of application programs. In other words, the system provided by the present invention may serve as a platform for integrating communication requests between a plurality of application programs and at least one electronic apparatus.

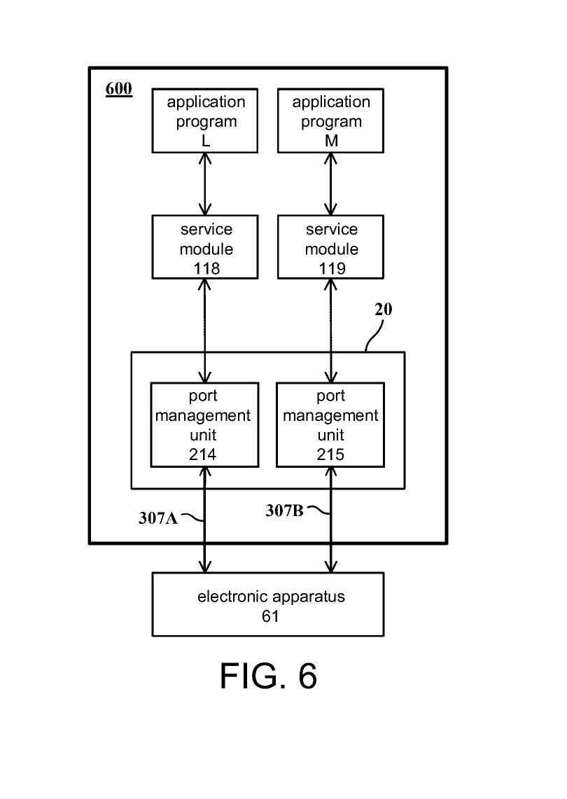

FIG. 6 shows an integration system 600 according to another embodiment of the present invention. In the embodiment, a service module 118 serves an application program L, and a service module 119 serves an application program M. The port management module 20 comprises port management units 214 and 215. The service module 118 is coupled to the port management unit 214, and the service module 119 is coupled to the port management unit 215. A first channel 307A and a second channel 307B are different channels included in a same transmission port, e.g., two channels formed by different end points of a same USB port. The application program L requests via the first channel 307A for a first-type data transmission, and the application program M requests via the second channel 207B for a second-type data transmission. For example, the application program L and the application program M may be installed to a computer system, and an electronic apparatus 61 is a mobile communication device. The application program L is for synchronizing the mobile communication device 61 with the computer system, and the application program M is for assisting the computer system to connect to a communication network of the mobile communication device 61 via the mobile communication device 61. Through the integration system 600, the application program L and the application program M, which originally cannot share the same transmission port, are integrated, such that the computer system is allowed to connect to the Internet via the mobile communication device 61 while synchronizing with the mobile communication device 61.

A computer-readable storage medium is further provided according to yet another embodiment of the present invention. The computer-readable storage medium stores a code readable and executable by a controller. The code assists a plurality of application programs to communicate with at least one transmission port. For example, the computer-readable storage medium may be a memory installed in a test system or a computer system, or an optical storage medium. After an application program among the application programs raises an communication request, a first code of the code establishes a service module for the application program. When the application program requests to communicate with at one of the at least one transmission port, a second code of the code determines whether a port management unit corresponding to the transmission port exists. When the port management exists, the second code designates a control authority of the port management unit to the service module of the application program. When the port management unit does not exist, the second code establishes the port management unit, and designates the control authority of the port management unit to the service module of the application program. The second code allows the control authority of the port management unit to be shared by a plurality of service modules.

An integration system and a test system for incorporating multiple application programs are provided as described in the embodiments of the present invention. Through architectures of the systems, a control authority of a transmission port can be shared by the application programs without making large alterations to codes of the individual application programs, thereby effectively solving the issue of one test program monopolizing the control authority of the transmission port.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An integration system, configured to incorporate a plurality of application programs, comprising:
a first transmission port;
a port management module, comprising a first port management unit for managing the first transmission port;
a first service module, corresponding to a first application program among the application programs, configured to assist the first application program to communicate with the port management module; and
a second service module, corresponding to a second application program among the application programs, configured to assist the second application program to communicate with the port management module;
wherein, when at least one of the first application program and the second application program requests to communicate with the first transmission port, the port management module allows the first service module and the second service module to share a control authority of the first management unit.

2. The integration system according to claim 1, wherein the first service module filters original data provided to the first transmission port according to a filter condition provided by the first test program to generate data requested by the first application program.

3. The integration system according to claim 1, further comprising:
a second transmission port;
wherein, when the first application program requests to communicate with the second transmission port, the port management module determines whether a second port management unit corresponding to the second transmission port exists; if not, the port management module establishes the second port management unit, and designates a control authority of the second port management unit to the first service module.

4. The integration system according to claim 3, wherein when the second application program requests to communicate with the second transmission port, the port management module allows the first service module and the second service module to share the control authority of the second port management unit.

5. The integration system according to claim 3, wherein the first transmission port is coupled to a first electronic apparatus, and the second transmission port is coupled to the first electronic apparatus or a second electronic apparatus different from the first electronic apparatus.

6. The integration system according to claim 3, wherein the first transmission port and the second transmission port are virtual ports, and a connection channel is established between the first transmission port and the second transmission port.

7. The integration system according to claim 1, wherein the first transmission port comprises a first channel and a second channel, the first application program is allowed to request for a first-type data transmission via the first channel, and the second application program is allowed to request for a second-type data transmission via the second channel.

8. The integration system according to claim 1, further comprising:
a client connection processing module, configured to establish a client processing unit for the application programs, respectively; and
a service connection processing module, configured toestablish a service processing unit for the application programs, respectively;
wherein, the first service module is formed by a first service processing unit and a first client processing unit corresponding to the first application program, and the second service module is formed by a second service processing unit and a second client processing unit corresponding to the second application program.

9. The integration system according to claim 8, wherein after establishing the first service processing unit for the first application program, the service connection processing module informs the client connection processing module of a first channel name corresponding to the first service processing unit; the client connection processing module establishes the first client processing unit connected to the first service processing unit for the first application according to the first channel name; and the first service module is formed by the first service processing unit and the first client processing unit.

10. A test system, comprising:
a first transmission port;
a port management module, comprising a first port management unit for managing the first transmission port;
a first test program;
a second test program′
a first service module, corresponding to a first application program among the application programs, for assisting the first application program to communicate with the port management module; and
a second service module, corresponding to a second application program among the application programs, for assisting the second application program to communicate with the port management module;
wherein, when at least one of the first application program and the second application program requests to communicate with the first transmission port, the port management module allows the first service module and the second service module to share a control authority of the first management unit.

11. The test system according to claim 10, wherein the first service module filters original data provided to the first transmission port according to a filter condition provided by the first test program to generate data requested by the first application program.

12. The test system according to claim 10, wherein the first test program sends a test command to a first electronic apparatus coupled to the first transmission port, and the second test program receives response data generated by the first electronic apparatus in response to the test command via the first transmission port.

13. The test system according to claim 10, further comprising:
a second transmission port;
wherein, when the first application program requests to communicate with the second transmission port, the port management module determines whether a second port management unit corresponding to the second transmission port exists; if not, the port management module establishes the second port management unit, and designates a control authority of the second port management unit to the first service module.

14. The test system according to claim 13, wherein when the second application program requests to communicate with the second transmission port, the port management module allows the first service module and the second service module to share the control authority of the second port management unit.

15. The test system according to claim 13, wherein the first transmission port and the second transmission port are coupled to a first electronic apparatus, the first test program sends a test command to the first electronic apparatus coupled to the first transmission port, and the second test program receives response data generated by the first electronic apparatus in response to the test command via the second transmission port.

16. The test system according to claim 13, wherein the first service module has the control authority of the first transmission port, and the second service module has the control authority of the second transmission port; the first transmission port and the second transmission port are virtual ports, and a connection channel is established between the first transmission port and the second transmission port; the second test program is for simulating an electronic apparatus tested by the first test program.

17. A computer-readable storage medium, storing a code readable and executable by a controller, the code for assisting a plurality of application programs to communicate with at least one transmission port; the code comprising:
a first code, for establishing a service module for an application program among the application programs after the application program raises an communication request; and
a second code, when the application program requests to communicate with at one of the at least one transmission port, for determining whether a port management unit corresponding to the transmission port exists; if yes, the second code designating a control authority of the application program to the service module of the application program; if not, the second code establishing the port management unit, and designating the control authority of the port management unit to the service module of the application program;
wherein, the second code allows the control authority of the port management unit to be shared by a plurality of service modules.

18. The computer-readable storage medium according to claim 17, wherein the service module comprises a service processing unit and a client processing unit; after the first code establishes the service processing unit for the application program, the first code establishes the client processing unit connected to the service processing unit for the application program according to a first channel name corresponding to the service processing unit.
